(19) United States
(12) Patent Application Publication
(10) Pub. No.: US 2010/0273620 A1
(43) Pub. Date: Oct. 28, 2010

(54) Insertion Method for Centered Thread in Filter Rod

(76) Inventor: Dave Lewis, London (GB)

Correspondence Address: CHADBOURNE & PARKE LLP, 30 ROCKEFELLER PLAZA, NEW YORK, NY, 10112, US

(21) Appl. No.: 12/669,477

(22) PCT Filed: Jun. 18, 2008
(86) PCT No.: PCT/EP08/57720

§ 371 Date: Jun. 25, 2010

(30) Foreign Application Priority Data
Jul. 25, 2007 (GB) 0714530.3

(51) Int. Cl. B31C 99/00

(52) U.S. Cl. 493/39

(57) ABSTRACT

A method and apparatus for preparing a rod for use in the preparation of a smoking article are provided. The method comprises: (i) providing a starting material for forming said rod; (ii) providing a solid support for location within said formed rod; (iii) providing rod forming means comprising a channel ending in an open exit; (iv) providing an elongate passage having a distal portion terminating in an open distal end within said channel; (v) drawing said solid support through said elongate passage by contacting it with said travelling starting material in said channel; (vi) concurrently introducing an additive into said elongate passage at a rate sufficient to maintain a predetermined minimum volume in said distal portion—such that said travelling solid support is coated and/or impregnated by said additive by continuous immersion in said additive in said distal portion; and (vii) allowing said formed rod comprising said solid support coated and/or impregnated by additive to exit from said open exit of said channel.

### FIELD OF THE INVENTION

The present invention relates to a method of forming a rod for use in the preparation of a smoking article. More particularly, the present invention relates to a method and apparatus for increasing loading levels of flavourants per unit length in a smoking article.

### BACKGROUND OF THE INVENTION

Rods with threads therein for use as filter rods are known. Examples of such rods are taught in U.S. Pat. No. 4,281,671 and US 2005/0255978. There are a number of problems associated with the methods disclosed therein for preparing the rod articles. For example, the methodology taught in U.S. Pat. No. 4,281,671 does not reliably allow manufacturers to accurately place the threads inside the rods. If, for example, it was desirous to have the thread running along the central axis of the rod then the method taught in U.S. Pat. No. 4,281,671 does not allow workers to create with some degree of accuracy such embodiments, meaning that the threads are prone to being off-centre. This can result in uneven migration of the menthol, which in some cases can result in spotting or similar spoilage of the casings or coverings or wrappers wrapped around filters etc. A problem with the methodology taught in US 2005/0255978 is that it is not best suited for the application of volatile flavourants, such as menthol, since the flavourants are coated onto the solid support at a location quite remote from the rod forming means.

A further problem associated with aforementioned prior art methods and apparatus is that the application of volatile flavourants, such as menthol, onto the thread is a limiting factor in terms of the overall rate of manufacture of the rods. For example, the application of higher loading levels of volatile flavourant necessarily results in a corresponding decrease in the overall rate of manufacture of rods measured in metres per minute. Conversely, increasing the overall rate of manufacture of rods necessarily results in a corresponding limitation in the loading levels of volatile flavourant applied to the thread. In the context of the present invention, the term “loading level” used herein is to be understood to mean the weight of additive or flavourant per millimetre of rod (or per 27 mm of rod).

For example, the methodologies taught in U.S. Pat. No. 4,281,671 and US 2005/0255978 each utilise a bath of flavourant solution. In each case a thread is drawn into the bath and subsequently exits the bath up-stream of the rod forming garniture. It will be appreciated that for a thread having a given absorbance level, the loading level of flavourant applied to the thread is proportional to the amount of time it is immersed in the flavourant bath. Accordingly, a high flavourant loading level can only be achieved by slowing the speed of the thread travelling through the bath, and hence slowing the rate of rod manufacture.

GB-A-2 070 409 discloses a method of producing a smoking material rod wherein smoking material, a filament comprising a smoke-modifying agent and a wrapper web are fed to a rod-forming device of a rod making machine in order to produce a wrapped rod incorporating the filament. However, the smoke-modifying agent is coated onto the filament prior to entry of the filament into the garniture of the rod making machine.

WO 2005/096851 discloses a method for preparing smoking articles wherein an extrudate is formed and applied to scattered tobacco. The extrudate contains a base constituent to which an additive has been discontinuously supplied. The additive is, therefore, applied remote from the tobacco rolling or rod forming means.

### SUMMARY OF THE INVENTION

The present invention seeks to overcome the problems inherent in the prior art. In this respect, the present invention provides a method of preparing a rod having therein a solid support wherein the solid support may be more accurately located inside of the rod, and wherein the support has coated on it an additive having a high loading level per unit length without compromising the overall rate of manufacture of rods.

The smoking article of the present invention comprises smokable material (sometimes referred to as “smoking material”) wrapped in a wrapper.

The term ‘smokable material’ means any material which can be used in a smoking article. It does not necessarily mean that the material itself will necessarily sustain combustion. The smokable material may be tobacco material or may, alternatively be a tobacco substitute material. A tobacco substitute material is usually produced as a sheet, and then cut to resemble cut tobacco. The smokable material may then be blended with other materials to produce a smokable filler material.

The smokable material is typically retained in the form of a rod, commonly known as a smokable material rod or a smoking material rod. These terms are merely intended to mean that part of the smoking article which is contained within the wrapper (which may be a paper or other wrapper, which other wrapper may or may not be combustible) and should not have imported therein any association as to the combustibility or otherwise of individual components of the rod of the smoking material.

The smoking article of the invention may take any form. For example the smoking article may be one in which the tobacco is smoked by igniting the smoking material and inhaling the products of combustion, as for example in a cigarette, cigar or cigarillo. Alternatively the smoking article may be one in which the smoking material is heated to a temperature at which decomposition in to pyrolysis products occurs without combustion. Such articles are well known and incorporate electrical or other heating means such as a charcoal element.

The preferred smoking article of the invention is a cigarette comprising a rod of tobacco, a wrapper, and a smoke filter wherein the filter comprises the rod of the present invention.

In particular the smoking article may comprise a rod of smoking material optionally in a casing, with or without a filter. The casing may be a wrapper of paper, tobacco leaf or reconstituted tobacco. Alternatively, where, for example, the smoking article is intended to produce low emissions of sidestream smoke, or lower levels of pyrolysis products in the mainstream smoke, the casing may be composed of non-combustible inorganic material such as a ceramic material. The filter may be of any suitable material, for example fibrous cellulose acetate, polypropylene or polyethylene, or paper.

The rod of the present invention has a first end and a second end. Located in the rod is a solid support. The solid support extends in a linear fashion from the first end of said rod to the second end of said rod.

Examples of solid supports include threads, tapes etc. that may be coated or impregnated with flavourants, in particular menthol if the smoking article is a cigarette.

According to a first embodiment of the invention there is provided a method of preparing a rod for use in the preparation of a smoking article, wherein said method comprises the steps of providing a starting material for forming said rod; providing a solid support for location within said formed rod; providing rod forming means comprising a channel ending in an open exit, wherein said starting material may travel through at least part of the channel and leave via the open exit as a formed rod; providing an elongate passage having a distal portion terminating in an open distal end within said channel; drawing said solid support through said elongate passage by contacting it with said travelling starting material in said channel; concurrently introducing an additive into said elongate passage at a rate sufficient to maintain a predetermined minimum volume in said distal portion such that said travelling solid support is coated and/or impregnated by additive by continuous immersion in said additive in said distal portion; and allowing said formed rod comprising said solid support coated and/or impregnated by additive to exit from said open exit of said channel.

According to a second embodiments of the invention there is provided an apparatus for forming a rod suitable for use in the preparation of a smoking article, said rod forming means comprising a channel ending in an open exit; means for conveying a starting material through at least part of the channel such that it leaves via the open exit as a formed rod; and means for conveying a solid support into said starting material within said channel; means for providing an additive for coating and/or impregnating at least a portion of said solid support; wherein said means for conveying said solid support comprises an elongate passage having a distal portion terminating in an open distal end within said channel, and wherein said means for providing an additive is adapted to introduce said additive into said elongate passage at a rate sufficient to maintain a predetermined minimum volume in said distal portion to facilitate the coating and/or impregnation of said solid support by continuous immersion in said additive whilst it travels through said distal portion.

The means may be separate means. Alternatively, two or more of the means may be the same.

According to a third embodiments of the invention there is provided an apparatus for preparing a rod suitable for use in the preparation of a smoking article; wherein said rod has a first end and a second end; wherein said rod has located therein a solid support; wherein the solid support extends in a linear fashion from the first end of said rod to the second end of said rod; wherein at least a portion of said solid support is coated and/or impregnated with an additive; wherein said apparatus comprises a rod forming means; wherein said rod forming means comprises: means for providing starting material for forming said rod; means for providing the solid support for location within said formed rod; means for providing an additive for coating and/or impregnating at least a portion of said solid support; means for coating and/or impregnating at least a portion of said solid support with said additive; means for allowing a section of said starting material to contact a section of said solid support coated and/or impregnated with said additive, wherein said solid support is continuously immersed in said additive at its point of exit from said means for allowing a section of said starting material to contact a section of said solid support coated and/or impregnated with said additive; and wherein the initial contact of said section of starting material with said section of said solid support occurs in said rod forming means.

According to a fourth embodiment of the invention there is provided a rod obtained by the method according to the present invention.

According to a fifth embodiment of the invention there is provided a method of forming a smoking article comprising using the method of the present invention or a rod according to the present invention.

One of the key differences between the method (and apparatus) of the present invention and method (and apparatus) of U.S. Pat. No. 4,281,671 and US 2005/0255978 lies in the initial contact between the starting material and the solid support material. In the case of U.S. Pat. No. 4,281,671, that initial contact occurs remote from the rod forming means. In the present invention, the initial contact takes place in the rod forming means. This has many advantages. For example, after contact the ability for the solid support material to move for example laterally is minimised—which means that workers can more accurately place the support material inside the rod. In the case of U.S. Pat. No. 4,281,671, the solid support material can move easily in a lateral direction, making the alignment prone to error etc. In addition, if the support material is impregnated with volatile flavourants—such as menthol—then with the present invention one can achieve higher dosing of the flavourant in the rod. This is because the flavourant does not have to travel very far—relative to the distances of the methodology taught in U.S. Pat. No. 4,281,671 and US 2005/0255978—to be encapsulated in the rod. Indeed, in the present invention, flavourant is applied to the support material immediately prior to the initial contact between the starting material and the solid support material.

In addition, it is possible with the present invention it is possible to use pure flavourants—such as pure menthol for the method; thereby minimising the use of carrier solvents etc. for the flavourant. In some instances, it may be possible to load the support material with sufficient flavourant thereby reducing or even eliminating the need to also load the tobacco with flavourant. Other advantages will be apparent to those skilled in the art in the light of the following commentary.

The step of introducing said additive into said elongate passage can be achieved by pumping means. The pumping means can pump additive into the elongate passage at a rate of between 100 g/minute and 400 g/minute, such as between 150 g/minute and 300 g/minute. The solid support coated and/or impregnated with said additive can travel at a rate of between 100-450 m/minute, such as between 190-410 m/minute. The continuous immersion of said solid support in said additive can achieve a loading level in said coated and/or impregnated solid support of between 0.5 mg/27 mm and 25 mg/27 mm, for example, between 5 mg/27 mm and 20 mg/27 mm.

All of said solid support can be coated with an additive. At least a part of the external surface of said rod can be covered with a cover. The cover can be paper. The edges of said cover can be fixed to each other by means of an adhesive. The adhesive can be a hot melt adhesive.

The additive can be a smoke-modifying agent such as a flavourant, which may be in substantially pure form. An example is menthol. The solid support can be a thread or a tape, and it may be coloured such as green.

The invention relates to preparing a rod for use in the preparation of a smoking article. Typically, but not exclusively, the smoking article will contain smokeable material such as tobacco. In a highly preferred aspect, the smoking article is a cigarette. Typically the smoking article comprises a filter rod and a tobacco rod; wherein the filter rod and a tobacco rod are joined together by means of a covering. In a preferred aspect, the present invention provides the filter rod.

Examples of additives for use in the present invention include but are not limited to burn additives, colourants, flavourants, filler materials, binders, aerosol generating means, ash improvers, catalysts, adsorbents, etc. Combinations of additives may be used.

Flavourant means any substance which releases, produces, neutralises, masks or alters odours, for example a perfume or deodorant. Flavouring agents may be designed to contribute towards an aerosol which has a unique but very acceptable taste and flavour characteristic to the aerosol smoke. The taste and flavour may not necessarily be designed to imitate tobacco smoke taste and flavour. Flavouring agents may include, for example, tobacco extract flavours, menthol, vanillin, peppermint, spearmint, isopinocampheol, isomenthone, mint cooler (commercially available from IFF), neomenthol, dill seed oil or other similar flavour materials, and mixtures thereof. The invention is suitable for any volatile or semi-volatile flavourant.

The additive may be mixed with a suitable carrier vehicle. For example, a menthol additive can be provided in a propylene glycol carrier, for example at a ratio of menthol to propylene glycol of 70:30. Additives may be encapsulated as is known in the art.

The solid support may be made from any suitable innoxious material which can absorb and/or be coated with additive. The shape of the support can be substantially similar along its longitudinal axis. The support may be coated with additional agents that facilitate the coating of the smoke-modifying agent(s) thereto—or ease the impregnation thereof. The support may be in the form of a thread of a tape.

The solid support extends longitudinally within said rod. The solid support can be positioned along the central longitudinal axis of the rod. At least one end of the solid material can be at one end of the rod. The ends of the solid material can be at opposite ends of the rod. In other words, all of the solid support can extend from the first end of said rod to the second end of said rod. Alternatively expressed, the lengths of the solid material and the rod can be the same.

Whilst the following description details a single solid support in the rod, the present invention does allow for two or more solid supports being present in the rod. In this respect, the solid supports may be different or similar.

The starting material may be any suitable staring material. For example, starting material can be cellulosic material suitable for forming a filter such as cellulose acetate. The starting material may be suitable for forming a filter, in particular a filter for a cigarette.

A filter of the present invention may be wrapped in a plug wrap. In addition, the filter may be attached to a rod of smoking material—such as a tobacco rod—by means of a tipping wrapper.

### BRIEF DESCRIPTION OF THE DRAWING FIGURES

In order that the subject invention may be easily understood and readily carried into effect, reference will now be made, by way of example, to the accompanying diagrammatic drawings, in which:

FIG. 1 shows views of a rod according to the present invention;

FIG. 2 shows the apparatus of U.S. Pat. No. 4,281,671;

FIG. 3 shows the apparatus of US 2005/0255978; and

FIG. 4 shows a diagrammatic cross-sectional view of the apparatus according to the present invention.

### DETAILED DESCRIPTION

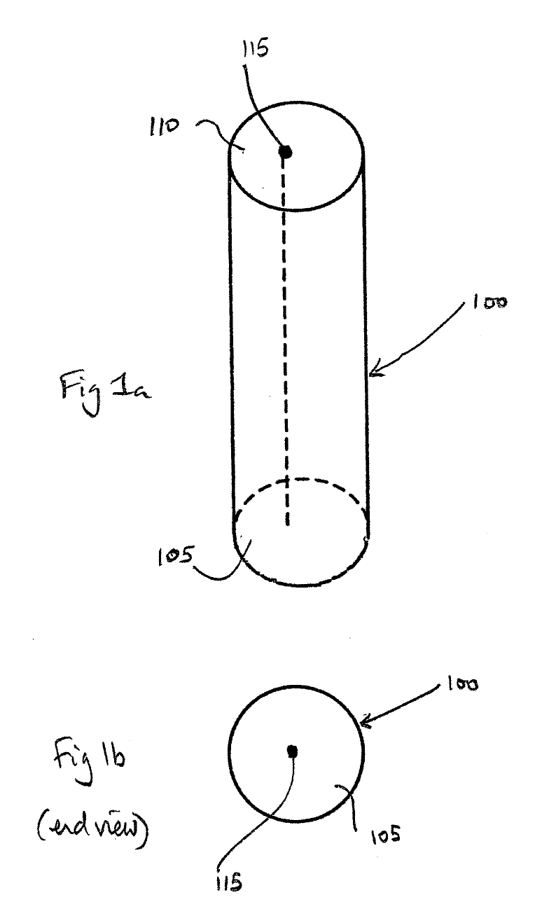

With reference to FIG. 1: The rod (100) of the present invention has a first end (105) and a second end (110). The rod has located therein a solid support (115). The solid support (115) extends in a linear fashion from the first end (105) of said rod to the second end of said rod (110). At least a portion of said solid support is coated and/or impregnated with an additive (not shown).

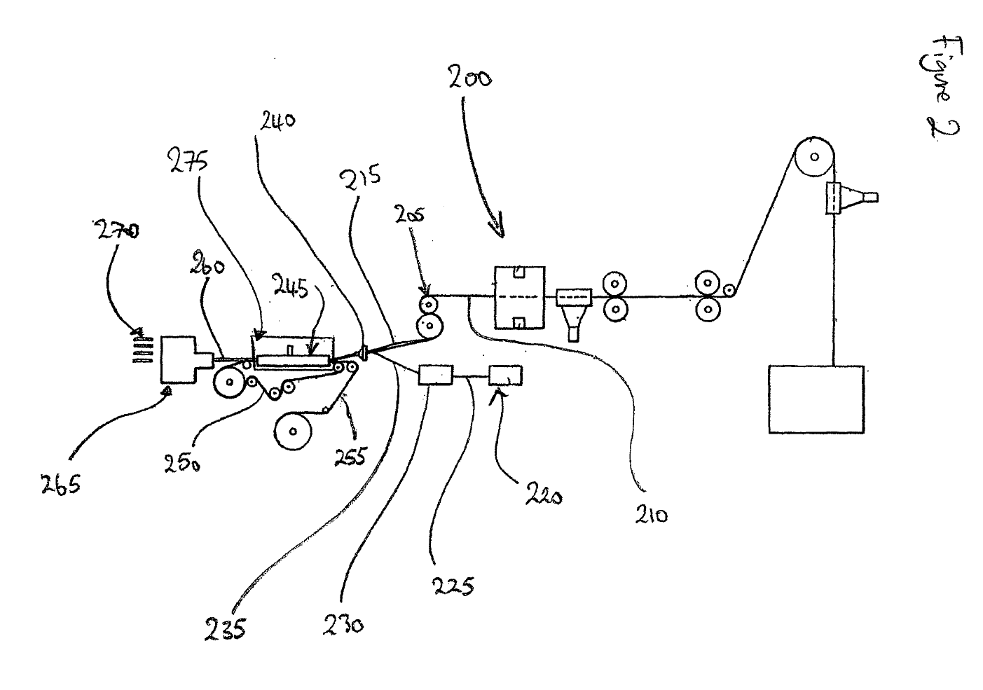

With reference to FIG. 2: The prior art apparatus (200) comprises means (205) for providing tow (210). The tow (210) is bloomed (215). The apparatus (200) comprises means (220) for delivering a thread (225). The thread (225) passes through means (230) for contacting the thread (225) with menthol (not shown). The treated thread (235) then joins the tow (215) before passing through funnel (240). The apparatus also comprises rod forming means (245)—which comprises a conveyor belt (250) onto which is located paper (255). The covered rod (260) then passes through cutting means (265) to form smaller rods (270) for use in the preparation of cigarettes (not shown). The area boxed in is known as the garniture (labelled 275).

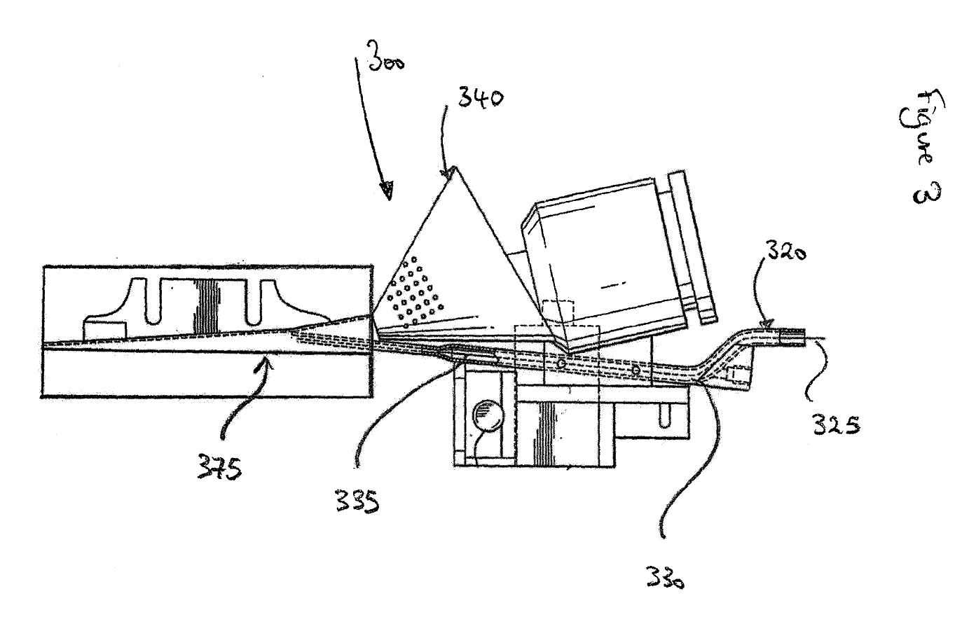

With reference to FIG. 3: The prior art apparatus (300) comprises means (not shown) for providing tow (not shown). The tow is bloomed (not shown). The apparatus (300) comprises means (320) for delivering a thread (325). The thread (325) passes through means (330) for contacting the thread (325) with menthol (not shown). The treated thread (335) then joins the tow (not shown) by by-passing the stuffer (340) before they reach the garniture (labelled 375). The apparatus comprises a garniture (375) as the rod forming means—and comprises a conveyor belt (not shown) onto which is located paper (not shown). The covered rod (not shown) then passes through cutting means (not shown) to form smaller rods (not shown) for use in the preparation of cigarettes (not shown). Again, the area boxed in is known as the garniture (labelled 375).

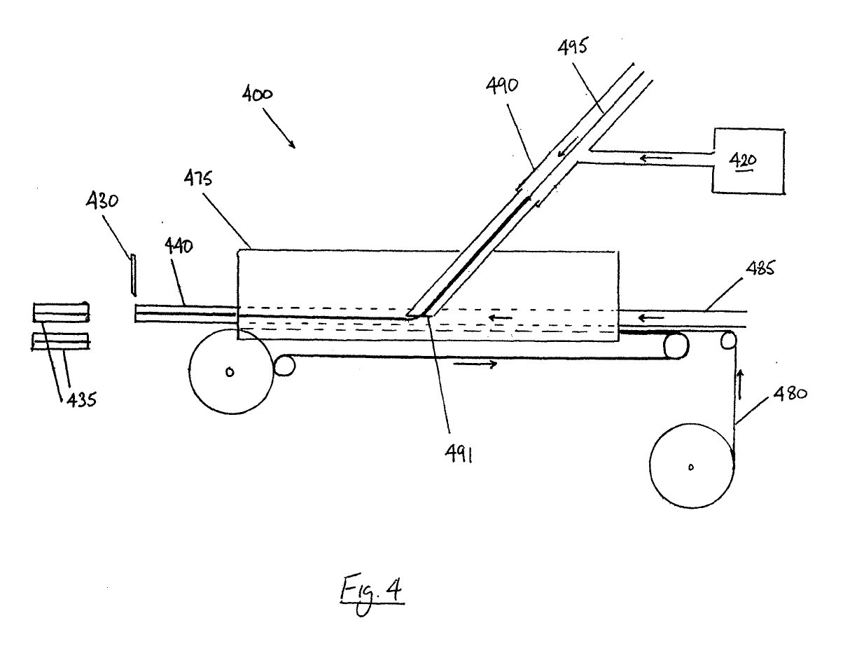

With reference to FIG. 4: The rod forming apparatus (400) of the present invention comprises a garniture (475) into which bloomed tow (cellulose acetate) (485) and paper (480) are conveyed by a conveyor belt. The apparatus further comprises an elongate tubular passage (490) having a distal portion terminating in an open distal end (491). The open distal end (491) of the elongate tubular passage (490) is positioned within the garniture (475) and free flowing thread (495) coated and/or impregnated with flavourant is drawn from the elongate tubular passage (490) into a selected portion of the travelling bloomed tow (485) before it is fully formed into a rod by the garniture (475).

The position of the distal end (491) of the elongate tubular passage (490) within the garniture (475) is selected such that the thread (495) is enclosed within the tow (485) and extends centrally through the formed rod as shown in FIG. 1. For example, bloomed tow (485) arriving in the garniture (475) from a stuffer has a typical diameter of 20-25 mm. As the bloomed tow (485) travels through the conical inner volume of the garniture (475) it becomes progressively more compressed.

The distal end (491) of the elongate tubular passage (490) is positioned in the garniture such that the initial contact between the thread (495) coated and/or impregnated with flavourant and the tow (485) occurs after the tow (485) has been partially compressed to an approximate diameter of 8 mm. This placement of the distal end (491) of the elongate tubular passage (490) within the garniture (475) inhibits migration of the flavourant to the outside of the tow and thereby retains the majority of flavourant centrally within the formed rod and increases the shelf life of smoking articles.

The continuous rod, designated (440), which issues from the outlet end of the garniture (475) is cut, by means of a blade indicated at (430), into discrete rod lengths (435). Each rod length (435) comprises a thread and resembles the rod of FIG. 1.

The distal portion of the elongate tubular passage (490) also defines a volume within which the thread (495) is coated and/or impregnated with flavourant as it passes through. A pump means (420) is provided up-stream of the distal portion of the elongate tubular passage (490) and introduces flavourant into the distal portion of the passage (490) at a rate sufficient to maintain a predetermined minimum volume in the distal portion. The predetermined minimum volume is selected such that the travelling thread (495) is continuously immersed in flavourant in the distal portion without being exposed to the ambient air. Any pump means which can introduce measured rates of flavourant in a controlled manner may be used such as that offered by Kaymich & Co Ltd as described in WO2006/010895.

The internal diameter of the distal portion of the elongate tubular passage (490) is optimised depending upon several variables, for example: (i) the diameter of the thread (495); (ii) the absorbance of the thread (495); and (iii) the viscosity/absorbability of the flavourant. In particular, the internal diameter of the distal portion of the elongate tubular passage (490) is selected such that high flavourant loading levels can be achieved in a standard 27 mm rod of the order of 5-25 mg per 27 mm rod. Such loading levels may be achieved at rod forming rates in the range 100-450 m/minute using appropriate flavourant pumping rates in the range 150-300 g/minute. For a thread (495) of typical absorbance having a diameter of 0.8 mm and coated and/or impregnated with a 70:30 menthol/propylene-glycol mix, it has been determined that the most appropriate internal diameter of the distal portion of the elongate tubular passage (490) is approximately 1.6-1.7 mm (+/−0.4 mm). Menthol requires higher pumping rates than some other flavourants due to the requirement for higher strength of flavour, and due to its inherent volatility. The coating and/or impregnation of threads with other less volatile flavourants can often be achieved using lower pumping rates.

Pure concentrated menthol crystals are melted at temperatures of 30-60° C. to liquefy them. However, the temperature requires alteration if a diluent or carrier solvent is used. Menthol crystals are supplied in 8 kg containers and their contents melt to provide approximately 9 litres of menthol flavourant. Accordingly, if the apparatus of the present invention is in constant operation, 5-6 changes of the menthol containers are required per day. To minimise interruption to production, subsequent cylinders require to be heated in readiness for use.

Alternatively, multiple pumps could be provided to pump different additives onto the thread (495). However, this may require alteration of the inner diameter of the distal portion of the elongate tubular passage (475) and/or the absorbency of the thread (495) to achieve acceptable loading levels subsequently added flavourants.

It will be appreciated that the apparatus of the present invention provides several advantages over the prior art. Firstly, by fully immersing the thread (495) in flavourant at the distal portion of the elongate tubular passage (475) any evaporative losses prior to contact with the tow (485) inherent in prior art apparatus can be minimised or eliminated. Moreover, optimisation of the internal diameter of the distal portion of the elongate tubular passage (475) acts to increase the loading level of flavourant on the thread (495) (i.e. the weight of flavourant per millimetre of rod).

With regard to the latter point, other than minimising or eliminating evaporative losses, two main principles are thought to be involved in obtaining superior loading levels of flavourant in the thread (495). Firstly, if the internal diameter of the distal portion of the elongate tubular passage (475) is adapted to be less than that of the remainder of the elongate tubular passage (475) then flavourant will experience a draw effect at the constriction whereby the motion of the thread (495) through the constriction attracts a higher loading of flavourant onto the thread (495). Also, the inner surface material of the distal portion of the elongate tubular passage (475) is chosen such that the draw of flavourant therethrough is relatively unimpeded thereby providing concurrent delivery of thread and flavourant drawn by the thread through the distal portion. The combined affect of the above two principles is that superior flavourant loading levels can be achieved without clogging the distal portion with flavourant, and without any compromise in the rate of rod formation inherent in the prior art. Indeed, although the absorbance of cellulose acetate tow (485) is greater than that of cotton thread (495), the apparatus of the present invention can nevertheless achieve comparable loading levels without the inherent disadvantages of applying flavourant directly in tow (485).

Various modifications and variations of the described aspects of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes of carrying out the invention which are obvious to those skilled in the relevant fields are intended to be within the scope of the following claims.

1. A method of preparing a rod for use in the preparation of a smoking article, wherein said method comprises:
providing a starting material for forming said rod;
providing a solid support for location within said formed rod;
providing rod forming means comprising a channel ending in an open exit, wherein said starting material travels through at least part of the channel and leaves via the open exit as a formed rod;
providing an elongate passage having a distal portion terminating in an open distal end within said channel;
drawing said solid support through said elongate passage by contacting said solid support with said traveling starting material in said channel;
concurrently introducing an additive into said distal portion of the elongate passage at a rate sufficient to maintain a predetermined minimum volume in said distal portion such that said traveling solid support is coated and/or impregnated by said additive by continuous immersion in said additive in said distal portion immediately prior to the initial contact between the starting material and the solid support; and
allowing said formed rod comprising said solid support coated and/or impregnated by said additive to exit from said open exit of said channel.

2. The method according to claim 1, wherein the introducing said additive into said elongate passage is achieved by pumping means.

3. The method according to claim 2, wherein the pumping means pumps additive into the elongate passage at a rate of between 100 g/minute and 400 g/minute.

4. The method according to claim 2, wherein the pumping means pumps additive into the elongate passage at a rate of between 150 g/minute and 300 g/minute.

5. The method according to claim 1, wherein said solid support coated and/or impregnated with said additive travels at a rate of between 100-450 m/minute.

6. The method according to claim 1, wherein said solid support coated and/or impregnated with said additive travels at a rate of between 190-410 m/minute.

7. The method according to claim 1, wherein the continuous immersion of said solid support in said additive achieves a loading level in said coated and/or impregnated solid support of between 0.5 mg/27 mm and 25 mg/27 mm.

8. The method according to claim 1, wherein the continuous immersion of said solid support in said additive achieves a loading level in said coated and/or impregnated solid support of between 5 mg/27 mm and 20 mg/27 mm.

9. The method according to claim 1, wherein all of said solid support is coated with said additive.

10. The method according to claim 1, wherein at least a part of the external surface of said rod is covered with a cover.

11. The method according to claim 10, wherein said cover is paper.

12. The method according to claim 10, wherein edges of said cover are fixed to each other by means of an adhesive.

13. The method according to claim 12, wherein said adhesive is a hot melt adhesive.

14. The method according to claim 1, wherein said rod is subsequently cut into a smaller rod for use in the preparation of a smoking article.

15. The method according to claim 14, wherein said rod or smaller rod is a filter rod.

16. The method according to claim 14, wherein said rod or smaller rod is a tobacco rod.

17. The method according to claim 14, wherein said smoking article is a cigarette.

18. The method according to claim 1, wherein said solid support is positioned along the central longitudinal axis of the rod.

19. The method according to claim 1, wherein the additive is a smoke-modifying agent.

20. The method according to claim 1, wherein the additive is a flavourant.

21. The method according to claim 1, wherein the additive is a flavourant in substantially pure form.

22. The method according to claim 1, wherein said additive is menthol.

23. The method according to claim 1, wherein at least one end of the solid material is at one end of the rod.

24. The method according to claim 1, wherein the ends of the solid material are at opposite ends of the rod.

25. The method according to claim 1, wherein a section of said starting material is an end of said starting material.

26. The method according to claim 1, wherein a section of said solid support is an end of said solid support.

27. The method according to claim 1, wherein said starting material enters the channel at an open entrance opposite the open exit.

28. The method according to claim 1, wherein said channel is conical.

29. The method according to claim 1, wherein said rod forming means is formed from at least two components that operably engage each other to form said channel.

30. The method according to claim 29, wherein the first component is a former in the shape of a tapered cone.

31. The method according to claim 29, wherein the second component is a conveyor belt.

32. The method according to claim 29, wherein the first component is a former in the shape of a tapered cone having a longitudinal opening and wherein the second component is a conveyor belt operably connectable with said opening.

33. The method according to claim 31, wherein said starting material is carried by said conveyor belt.

34. The method according to claim 31, wherein said starting material is carried on paper by said conveyor belt.

35. The method according to claim 34, wherein said paper provides a covering for said rod.

36. The method according to claim 35, wherein at least one edge of said paper carries an adhesive.

37. The method according to claim 36, wherein said adhesive is a hot melt adhesive.

38. The method according to claim 1, wherein said rod forming means comprises a garniture.

39. The method according to claim 1, wherein said rod forming means comprises a garniture defining said channel.

40. The method according to claim 38, wherein the initial contact of the solid support with said starting material occurs whilst the starting material is located in the garniture.

41. The method according to claim 1, wherein said starting material is of a planar shape.

42. The method according to claim 1, wherein said starting material is cellulosic.

43. The method according to claim 1, wherein said starting material is cellulose acetate.

44. The method according to claim 1, wherein starting material is tow.

45. The method according to claim 1, wherein starting material is bloomed tow.

46. The method according to claim 1, wherein at least a portion of the starting material may be modified by coating and/or impregnating thereon and/or admixing therewith said additive.

47. The method according to claim 46, wherein the additive is a smoke-modifying agent.

48. The method according to claim 47, wherein the smoke-modifying agent is a flavourant.

49. The method according to claim 48, wherein said flavourant is menthol.

50. The method according to claim 1, wherein said solid support is a tape.

51. The method according to claim 50, wherein said solid support is a thread.

52. The method according to claim 1, wherein said solid support is colored.

53. The method according to claim 47, wherein said solid support is colored and wherein the color is indicative of the smoke modifying agent.

54. The method according to claim 1, wherein said solid support is colored green.

55. An apparatus for forming a rod suitable for use in the preparation of a smoking article, said rod forming means comprising:
a channel ending in an open exit;
means for conveying a starting material through at least part of the channel such that it leaves via the open exit as a formed rod; and
means for conveying a solid support into said starting material within said channel;
means for providing an additive for coating and/or impregnating at least a portion of said solid support;
wherein said means for conveying said solid support comprises an elongate passage having a distal portion terminating in an open distal end within said channel, and
wherein said means for providing an additive is adapted to introduce said additive into said distal portion of the elongate passage at a rate sufficient to maintain a predetermined minimum volume in said distal portion to facilitate the coating and/or impregnation of said solid support by continuous immersion in said additive while it travels through said distal portion and immediately prior to an initial contact between the starting material and the solid support.

56. The apparatus according to claim 55, wherein the elongate passage is tubular.

57. The apparatus according to claim 56, wherein the internal diameter of the tubular passage at its open distal end is between 0.6 mm and 2.8 mm.

58. The apparatus according to claim 56, wherein the internal diameter of the tubular passage at its open distal end is between 1.2 mm and 2.0 mm

59. The apparatus according to claim 56, wherein the internal diameter of the tubular passage at its open distal end is between 1.6 mm and 1.7 mm.

60. The apparatus according to claim 55, wherein the means for providing an additive for coating and/or impregnating at least a portion of said solid support is a pumping means.

61. The apparatus according to claim 60, wherein the pumping means pumps said additive into the elongate passage at a rate of between wog/minute and 400 g/minute.

62. The apparatus according to claim 60, wherein the pumping means pumps said additive into the elongate passage at a rate of between 150 g/minute and 300 g/minute.

63. The apparatus according to claim 55, wherein said solid support coated and/or impregnated with said additive travels at a rate of between 100-450 m/minute.

64. The apparatus according to claim 55, wherein said solid support coated and/or impregnated with said additive travels at a rate of between 190-410 m/minute.

65. The apparatus according to claim 55, wherein the elongate passage declines towards its open distal end.

66. An apparatus for preparing a rod suitable for use in the preparation of a smoking article; wherein said rod has a first end and a second end; wherein said rod has located therein a solid support; wherein the solid support extends in a linear fashion from the first end of said rod to the second end of said rod; wherein at least a portion of said solid support is coated and/or impregnated with an additive; wherein said apparatus comprises:
a rod forming means;
wherein said rod forming means comprises:
means for providing starting material for forming said rod; means for providing the solid support for location within said formed rod;
means for providing an additive for coating and/or impregnating at least a portion of said solid support;
means for coating and/or impregnating at least a portion of said solid support with said additive; and
means for allowing a section of said starting material to contact a section of said solid support coated and/or impregnated with said additive, wherein said solid support is continuously immersed in said additive at its point of exit from said means for allowing a section of said starting material to contact a section of said solid support coated and/or impregnated with said additive;
wherein the initial contact of said section of starting material with said section of said solid support occurs in said rod forming means; and
wherein said means for coating and/or impregnating at least a portion of said solid support with said additive is configured to coat and/or impregnate it immediately prior to said point of exit from said means for allowing a section of said starting material to contact a section of said solid support.

67. A rod obtained by the method according to claim 1.

68. The method according to claim 1, wherein said rod is then used to prepare a smoking article.

69. The method according to claim 68, wherein said smoking article is a cigarette.

70. A cigarette obtained by the method according to claim 69.
